(19) United States
(12) Patent Application Publication
(10) Pub. No.: US 2022/0259025 A1
(43) Pub. Date: Aug. 18, 2022

(54) Jack Block

(71) Applicant: Kyle C. Harvey, Fairview, OR (US)

(72) Inventor: Kyle C. Harvey, Fairview, OR (US)

(21) Appl. No.: 17/578,221

(22) Filed: Jan. 18, 2022

Related U.S. Application Data
(60) Provisional application No. 63/150,892, filed on Feb. 18, 2021.

(51) Int. Cl. B66F 13/00

(52) U.S. Cl. CPC B66F 13/00

(57) ABSTRACT

The present invention provides a block device that comprises a main member having main holes and a main channel. A sub member having sub holes and a sub channel is rotatably connected to the main member by plurality of connecting members. The sub member is substantially centrally disposed within the main channel and the sub member includes a sub bottom wall with an angled surface.

### FIELD OF THE INVENTION

The present invention generally relates to a leveling device. More specifically, the present invention relates to a device that can be used to level a vehicle.

### BACKGROUND OF THE INVENTION

An efficient device that can be used to level a vehicle is in demand. When a vehicle has been parked at a parking location or at a roadside site, the vehicle operator may need to level the vehicle relative to the ground for many reasons, including to conduct repairs.

Many vehicles are equipped with a system for doing so, such as through the use of multiple hydraulic and/or motorized lifts or leveling jacks. Vehicle operators can stop and park their vehicles in a parking lot, which can be so uneven that the parked vehicle is tilted or uneven. This unevenness of the ground can create unsafe or uncomfortable conditions in and around the vehicle, which in some circumstances can impair the engine or the function of appliances in the vehicle.

Conventional jacking systems and jack block pads or supports can be used to level the vehicle by compensating for uneven ground conditions, but their use may take a significant amount of time and can be unsafe.

The operator may not be able to determine whether the system or support devices can level the vehicle safely at a given location until after attempting to level the vehicle. Such an inability can cause frustration, and when a heavy item is raised by a jack, the weight distribution of the item is unknown, so that the lifted item can become unstable as it leans or tips.

Conventional jack pads can lose contact area with a car bottom as the jack rises and the angle between car and pad increases. Thus, there is a need to develop a device that solves these problems.

The present invention is intended to address problems associated with and/or otherwise improve on conventional devices through an innovative device that is designed to provide a convenient, effective, and safe means of leveling a vehicle while incorporating other problem-solving features.

### SUMMARY

In accordance with the present invention, a block device is provided.

The block device comprises a main member, a sub member, and a connecting member.

The sub member can be rotatably connected to the main member by the connecting member to form the block device of the present invention.

In one embodiment, the main member includes a main channel configured to accommodate the sub member.

The sub member can also include a sub channel that extends from one sub side wall to the other. The sub channel may allow for clearance of a protruding structure of a vehicle, such as the pinch weld on the underbody of an automobile or truck.

The block device can be placed on the pad of a floor jack with the main member in contact with the floor jack and the sub member in contact with the underside of a vehicle to lift the vehicle. As the floor jack is raised, the block device will compensate for the vehicle's change in angle relative to the floor jack pad, with the sub member pivoting within the main member to maintain full contact with the lifted vehicle providing a stable and safe vehicle lift.

### BRIEF DESCRIPTION OF THE DRAWINGS

FIG. 1 is an illustration of one embodiment of the present invention.

FIG. 2 is a top view of one embodiment of the present invention.

FIG. 3 is a side view of one embodiment of the present invention.

FIG. 4 is a front view of one embodiment of the present invention.

FIG. 5 is a bottom view of one embodiment of the present invention.

FIG. 6 is an exploded view of one embodiment of the present invention.

### DETAIL DESCRIPTIONS OF THE INVENTION

All illustrations of the drawings are for the purpose of describing selected versions of the present invention and are not intended to limit the scope of the present invention.

The present invention provides a device for a stable and safe vehicle lift. The present invention includes a design that can maintain full contact with the vehicle bottom as the jack rises.

The present invention includes a pivoting contact surface, whereas similar conventional devices are fixed in place and do not allow for stable lifting as the jack rises and the angle of the lifted object changes, with the contact area of the lifted item instead shrinking as the angle of the lifted item relative to the lifting jack grows.

A smaller contact area on the item being lifted by a jack creates an unstable condition in which the object can fall, causing damage to persons or property.

The present invention device can be used to maintain full contact between any two objects where parallelism is absent.

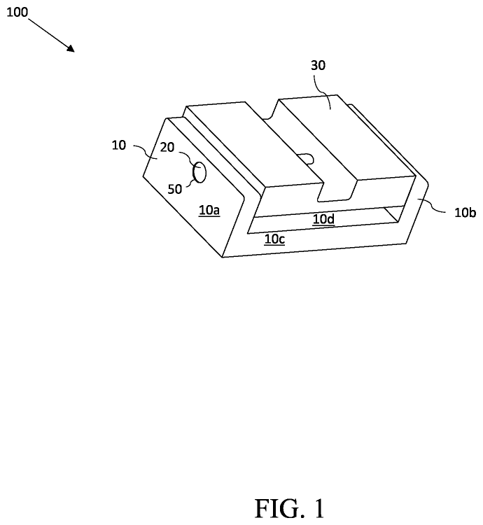

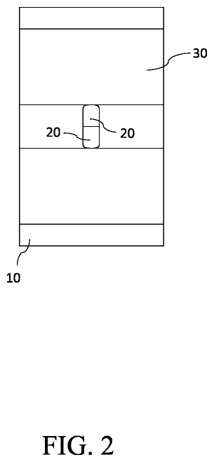

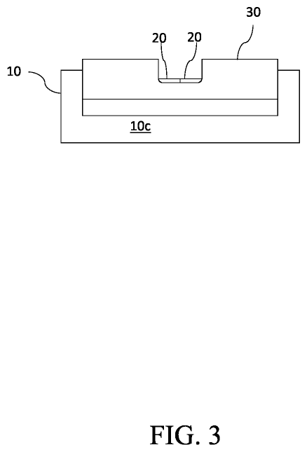

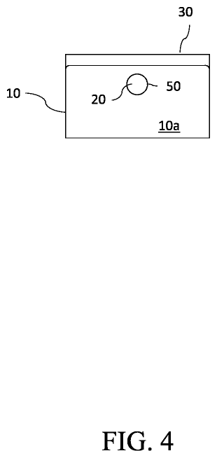

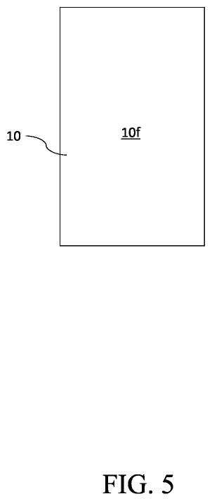

As FIGS. 1 to 6 show, the present invention provides a block device 100 that comprises a main member 10, a sub member 30, and a plurality of connecting members 20.

The sub member 30 can be rotatably connected to the main member 10 by the connecting member 20 to form the block device 100 of the present invention.

The main member 10 can be any suitable size and shape and made of a material suitable for supporting the vehicle, such as metal.

The main member 10 may include a front wall 10a, a rear wall 10b, a pair of side walls 10c, a top wall 10d and a bottom wall 10f.

The rear wall 10b is disposed substantially parallel to the front wall 10a, with both the front wall 10a and the rear wall 10b defining the longitudinal ends of the main member 10. The pair of side walls 10c adjoins the front wall 10a and the rear wall 10b. The side walls 10c lean toward each other.

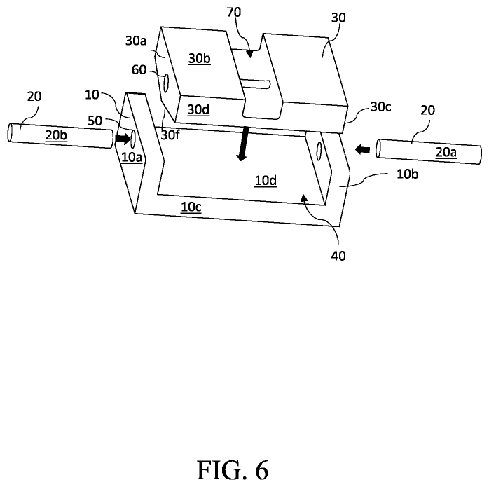

In one embodiment, the main member 10 can be a block with a main channel 40, which can be of a U shape, as shown in FIG. 6, configured to accommodate the sub member 30. For example, the main member 10 can include a main channel 40 which extends from one side wall 10c to the other opposite side wall 10c, where the main channel 40 includes a width adapted to enable traversal of a sub member 30 that can be substantially centrally disposed within the main channel 10.

The main member 10 may also include a main hole 50 that extends from the front wall 10a to the inner surface of the main channel 40 and from the inner surface of the main channel 40 to the rear wall 10b so that the main channel 40 can include two main holes 50 with the same axis direction, traversing from the front wall 10a to the rear wall 10b.

In preferred embodiments, the main member 10 is a metal block, substantially rectangular, having a main channel 40, as shown in FIG. 1.

The sub member 30 can also be any suitable size and shape and made of a material suitable for supporting the vehicle, such as metal, and allowing it to fit inside the main channel 40 provided by the main member 10, as shown in FIG. 1.

The sub member 30 may include a sub front wall 30a, a sub rear wall 30c, a pair of sub side walls 30d, a sub top wall 30b, and a sub bottom wall 30f. The sub rear wall 30c can be disposed substantially parallel to the sub front wall 30a. The pair of sub side walls 30d can adjoin the sub front wall 30a and the sub rear wall 30c. The sub side walls 30d can lean toward each other. In some embodiments, the sub bottom wall 30f can include an angled surface, as shown in FIG. 6.

The sub member 30 can also include a sub channel 70 that extends from one sub side wall 30d to the other. The sub channel 70, which can be of a U shape, as shown in FIG. 6, may allow for clearance of a protruding structure of a vehicle, such as the pinch weld on the underbody of an automobile or truck.

The sub member 30 may also include a sub hole 60 that extends from the sub front wall 30a to the sub inner surface of the sub channel 70 and from the sub inner surface of the sub channel 70 to the sub rear wall 30c so that the sub channel 70 can include a sub hole 60 traversing from the sub front wall 30a to the sub rear wall 30c.

The connecting member 20 can be a structure configured to connect the main member 10 and the sub member 30 so that the sub member 30 can pivot about the center line of the structure (connecting member 20).

In some embodiments, the connecting member 20 can be a pin sized to fit into the main holes 50 and the sub holes 60, as shown in FIG. 6. The main member 10 and the sub member 30 can be connected by placing the sub member 30 into the main channel 40 of the main member 10 and inserting the pin into the main hole 50 and the sub holes 60.

In some embodiments, the connecting member 20 may include a right pin 20a and a left pin 20b, with the right pin 20a able to connect the right portion of the main member 10 and the sub member 30 and the left pin 20b to connect the left portion of the main member 10 and the sub member 30 through the main holes 50 and the sub holes 60.

In some embodiments, rubber pads can be attached to the sub top wall 30b of the sub member 30 to provide friction for the surface and the item that may be in direct contact with the sub top wall 30b.

To use, place the sub member 30 into the main channel 40 of the main member 10. Align the main holes 50 and the sub holes 60, then insert the right pin 20a into the sub hole 60 and main hole 50 on the rear wall 10b and sub rear wall 30c, secured in place using a mechanical press. Place the left pin 20b in the main hole 50 and the sub hole 60 at the opposite end of the block device 100 and press into place. Attach rubber pads to the sub top wall 30b of the sub member 30 using adhesive.

When used to lift a vehicle, the block device 100 can be placed on the pad of a floor jack with the main member 10 in contact with the floor jack and the sub member 30 in contact with the underside of a vehicle. As the floor jack is raised, the block device 100 will compensate for the vehicle's change in angle relative to the floor jack pad, with the sub member 30 pivoting within the main member 10 to maintain full contact with the lifted vehicle.

Although the invention has been explained in relation to its preferred embodiment, it is to be understood that many other possible modifications and variations can be made without departing from the spirit and scope of the invention.

What is claimed is:

1. A block device comprising:
a main member having one or more main holes including:
a front wall;
a rear wall disposed substantially parallel to the front wall, with both the front wall and the rear wall defining the longitudinal ends of the block device;
a pair of side walls positioned opposite to each other;
a top wall;
a bottom wall; and
a main channel that extends from one side wall to the other opposite side wall;
a plurality of connecting members;
a sub member having one or more sub holes and a sub channel; the sub member is rotatably connected to the main member by the connecting members traversing through the one or more main holes and the one or more sub holes; the sub member substantially centrally disposed within the main channel; and the sub member includes a sub bottom wall with an angled surface.

2. The block device of claim 1, wherein the main channel is of a U shape.

3. The block device of claim 1, wherein the sub channel is of a U shape.

4. The block device of claim 1, wherein the connecting members include a left pin and a right pin.

5. The block device of claim 1, wherein the sub bottom wall includes a V-shaped bottom extending throughout the sub bottom wall's length.

6. The block device of claim 1, wherein the sub member is attached to rubber pads.

7. A block device comprising:
a main member having one or more main holes including:
a front wall;
a rear wall disposed substantially parallel to the front wall, with both the front wall and the rear wall defining the longitudinal ends of the block device;
a pair of side walls positioned opposite to each other;
a top wall;
a bottom wall; and
a main channel that extends from one side wall to the other opposite side wall;
a plurality of connecting members including a left pin and a right pin;
a sub member having one or more sub holes and a sub channel; the sub member is rotatably connected to the main member by the connecting members traversing through the one or more main holes and the one or more sub holes; the sub member substantially centrally disposed within the main channel; and the sub member includes a sub bottom wall with an angled surface of a V-shape.

8. The block device of claim 7, wherein the main channel is of a U shape.

9. The block device of claim 7, wherein the sub channel is of a U shape.

10. The block device of claim 7, wherein the sub member is attached to rubber pads.

11. A block device comprising:
a main member having one or more main holes including:
a front wall;
a rear wall disposed substantially parallel to the front wall, with both the front wall and the rear wall defining the longitudinal ends of the block device;
a pair of side walls positioned opposite to each other;
a top wall;
a bottom wall; and
a main channel of a U shape that extends from one side wall to the other opposite side wall;
a plurality of connecting members including a left pin and a right pin;
a sub member having one or more sub holes and a sub channel of a U shape; the sub member is rotatably connected to the main member by the connecting members traversing through the one or more main holes and the one or more sub holes; the sub member substantially centrally disposed within the main channel; and the sub member includes a sub bottom wall with an angled surface of a V-shape.

12. The block device of claim 11, wherein the sub member is attached to rubber pads.
